(19) United States
(12) Patent Application Publication
(10) Pub. No.: US 2020/0264280 A1
(43) Pub. Date: Aug. 20, 2020

(54) CONTROL METHOD FOR TIME-OF-FLIGHT SENSING SYSTEM

(71) Applicants: Lite-On Electronics (Guangzhou) Limited, Guangzhou (CN); LITE-ON TECHNOLOGY CORPORATION, Taipei (TW)

(72) Inventors: Shou-Te WEI, Taipei (TW); Wei-Chih CHEN, Taipei (TW); Jun-Hao WU, Taipei (TW)

(21) Appl. No.: 16/589,196

(22) Filed: Oct. 1, 2019

Related U.S. Application Data
(60) Provisional application No. 62/807,246, filed on Feb. 19, 2019.

(30) Foreign Application Priority Data
Apr. 2, 2019 (CN) 201910263049.9

(51) Int. Cl. G01S 7/48; G01S 17/08

(52) U.S. Cl. CPC G01S 7/4808; G01S 17/08

(57) ABSTRACT

A control method for a time-of-flight sensing system includes the following steps. Firstly, a modulation signal with a specified period is provided. The specified period is divided into a first time segment and a second time segment. Then, the modulated light source is disabled. A reflection signal generated by the photo detector in each first time segment is transmitted to a first sensing circuit. The reflection signal generated by the photo detector in each second time segment is transmitted to a second sensing circuit. Consequently, a first sensing value and a second sensing value are generated. If the time-of-flight sensing system is not interfered, the modulated light source is enabled, and the modulated light source emits a modulated light according to the modulation signal. If the time-of-flight sensing system is interfered, the specified period of the modulation signal is changed.

This application claims the benefit of U.S. provisional application Ser. No. 62/807,246, filed Feb. 19, 2019 and People's Republic of China Patent Application No. 201910263049.9, filed Apr. 2, 2019, the subject matter of which is incorporated herein by reference.

### FIELD OF THE INVENTION

The present invention relates to a control method for a sensing system, and more particularly to a control method for a time-of-flight (TOF) sensing system.

### BACKGROUND OF THE INVENTION

With the development of science and technology, the 3D sensing technology has been gradually matured and used in various electronic products. For example, a time-of-flight (TOF) sensing technology is one of the 3D sensing technologies. The TOF sensing system may be installed in a sweeping robot, a self-driving vehicle, an automatic guided vehicle, a head-mounted display (e.g., Goggles) in an augmented reality (AR) game, or any other appropriate electronic product. Consequently, the electronic product has the 3D sensing function.

FIG. 1A schematically illustrates the concept of using a TOF sensing system to detect a distance. FIG. 1B is a schematic timing waveform diagram illustrating associated signal processed by the TOF sensing system as shown in FIG. 1A.

As shown in FIG. 1A, the TOF sensing system 100 comprises a modulated light source 102 and a photo detector 104. The modulated light source 102 emits a modulated light Lm according to a modulation signal Sm. When the modulated light Lm is projected on an object 110, a reflected light Lr is generated and projected to the photo detector 104. When the reflected light Lr is received by the photo detector 104, a reflection signal Sr is generated. For example, the reflection signal Sr is a sensing current.

Please refer to FIG. 1B. In the TOF sensing system 100, the modulation frequency and the duty cycle of the modulation signal Sm are identical to those of the reflection signal Sr. According to the modulation signal Sm and the reflection signal Sr, the TOF sensing system 100 calculates a phase delay value Trt and calculates a distance between the object 110 and the TOF sensing system 100. Generally, in case that the phase delay value Trt is larger, the distance between the object 110 and the TOF sensing system 100 is longer.

Generally, the TOF sensing system comprises more than one photo detector. For example, another conventional TOF sensing system comprises a photo detecting matrix comprises plural photo detectors, wherein are arranged in an M×N (e.g., 240×180) array. Similarly, the sensing circuit of the TOF sensing system can calculate M×N phase delay values corresponding to the M×N photo detectors and obtain a 3D information about the surface of the object 110.

However, if plural TOF sensing systems are located in the same scene, these TOF sensing systems may interfere with each other. FIG. 2 schematically illustrates the interference between two TOF sensing systems. The modulation frequency of a first modulation signal Sm of the first TOF sensing system 200 and the modulation frequency of a second modulation signal Sm′ of the second TOF sensing system 220 are equal.

Please refer to FIG. 2 again. The modulated light source 202 of the first TOF sensing system 200 emits a first modulated light Lm according to the first modulation signal Sm. When the first modulated light Lm is projected on an object 210, a first reflected light Lr is generated and projected to the photo detector 204 of the first TOF sensing system 200. Similarly, the modulated light source 222 of the second TOF sensing system 220 emits a second modulated light Lm′ according to the second modulation signal Sm′. When the second modulated light Lm′ is projected on the object 210, a reflected light (not shown) is projected to the photo detector 224 of the second TOF sensing system 220 and a second reflected light Lr′ is projected to the photo detector 204 of the first TOF sensing system 200.

In other words, the photo detector 204 of the first TOF sensing system 200 receives the first reflected light Lr and the second reflected light Lr′. According to the first reflected light Lr and the second reflected light Lr′, the photo detector 204 of the first TOF sensing system 200 generates a first reflection signal Sr. Since the modulation frequency of the first modulation signal Sm and the modulation frequency of the second modulation signal Sm′ are equal, the second reflected light Lr′ may influence the first reflection signal Sr generated from the photo detector 204. Since the phase delay value Trt is calculated according to the first modulation signal Sm and the first reflection signal Sr, the phase delay value Trt calculated by the first TOF sensing system 200 may be erroneous. Under this circumstance, the obtained distance between the object 210 and the first TOF sensing system 200 is not accurate.

Similarly, the photo detector 224 of the second TOF sensing system 220 receives two reflected lights (not shown). Consequently, the second reflection signal Sr′ generated from the photo detector 224 is also influenced. Since the phase delay value Trt is calculated according to the second modulation signal Sm′ and the second reflection signal Sr′, the phase delay value Trt calculated by the second TOF sensing system 220 may be erroneous. Under this circumstance, the obtained distance between the object 210 and the second TOF sensing system 220 is not accurate.

For avoiding the interference between plural TOF sensing systems, the modulation frequencies of the modulation signals of these TOF sensing systems are adjusted. When the modulation frequencies of the modulation signals of these TOF sensing systems are different, the interference between the plural TOF sensing systems is avoided.

Please refer to FIG. 2 again. If the modulation frequency of the first modulation signal Sm and the modulation frequency of the second modulation signal Sm′ are different, the second reflected light Lr′ corresponding to the second modulated light Lm′ is considered as the ambient light by the photo detector 204 of the first TOF sensing system 200. That is, the generation of the first reflection signal Sr is not influenced by the second reflected light Lr′, and the photo detector 204 generates the first reflection signal Sr according to only the first reflected light Lr. Consequently, the phase delay value Trt calculated by the first TOF sensing system 200 is accurate.

Similarly, the generation of the second reflection signal Sr′ by the photo detector 224 of the second TOF sensing system 220 is not influenced by the first reflected light Lr. Consequently, the phase delay value Trt calculated by the second TOF sensing system 220 is accurate.

Moreover, it is necessary to perform a handshaking process to confirm that the modulation frequencies of the modulation signals of these TOF sensing systems are different. If the handshaking process is not performed, the interference between plural TOF sensing systems still occurs.

For example, while an augmented reality (AR) game is being played by plural players, the TOF sensing systems of the head-mounted displays worn on the plural players may interfere with each other. Moreover, while plural automatic guided vehicles are operated in a warehouse simultaneously, the TOF sensing systems of the automatic guided vehicles may interfere with each other.

### SUMMARY OF THE INVENTION

An embodiment of the present invention provides a control method for a time-of-flight sensing system. The time-of-flight sensing system includes a modulated light source, a photo detector, a first sensing circuit and a second sensing circuit. The control method includes the following steps. Firstly, a modulation signal with a specified period is provided. The specified period is divided into a first time segment and a second time segment. Then, the modulated light source is disabled. A reflection signal generated by the photo detector in each first time segment is transmitted to the first sensing circuit. The reflection signal generated by the photo detector in each second time segment is transmitted to the second sensing circuit. Consequently, the first sensing circuit generates a first sensing value and the second sensing circuit generates a second sensing value. Then, a step is performed to judge whether the time-of-flight sensing system is interfered according to the first sensing value and the second sensing value. If the time-of-flight sensing system is not interfered, the modulated light source is enabled, and the modulated light source emits a modulated light according to the modulation signal. If the time-of-flight sensing system is interfered, the specified period of the modulation signal is changed.

Another embodiment of the present invention provides a control method for a time-of-flight sensing system. The time-of-flight sensing system includes a control method for a time-of-flight sensing system. The time-of-flight sensing system includes a modulated light source, a photo detecting matrix and plural sensing modules. The photo detecting matrix includes plural photo detectors. The plural photo detectors are connected with the corresponding sensing modules. The control method includes the following steps. Firstly, a modulation signal with a specified period is provided. The specified period is divided into a first time segment and a second time segment. Then, the modulated light source is disabled. A reflection signal generated by each photo detector in each first time segment is transmitted to a first sensing circuit of the corresponding sensing module. The reflection signal generated by each photo detectors in each second time segment is transmitted to a second sensing circuit of the corresponding sensing module. Consequently, the first sensing circuit generates a first sensing value and the second sensing circuit generates a second sensing value. Then, a step is performed to judge whether each sensing module is interfered according to the first sensing value and the second sensing value. If the number of the interfered sensing modules is smaller than the threshold count, the modulated light source is enabled. Consequently, the modulated light source emits a modulated light according to the modulation signal. If the number of the interfered sensing modules is larger than the threshold count, the specified period of the modulation signal is changed.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A (prior art) schematically illustrates the concept of using a TOF sensing system to detect a distance;

FIG. 1B (prior art) is a schematic timing waveform diagram illustrating associated signal processed by the TOF sensing system as shown in FIG. 1A;

FIG. 2 (prior art) schematically illustrates the interference between two TOF sensing systems;

FIG. 3A is a schematic circuit block diagram illustrating the architecture of a TOF sensing system according to an embodiment of the present invention;

FIG. 3B is a schematic timing waveform diagram illustrating associated signal processed by the TOF sensing system as shown in FIG. 3A;

FIG. 4 is a flowchart illustrating a control method for a TOF sensing system according to a first embodiment of the present invention; and

FIG. 5 is a flowchart illustrating a control method for a TOF sensing system according to a second embodiment of the present invention.

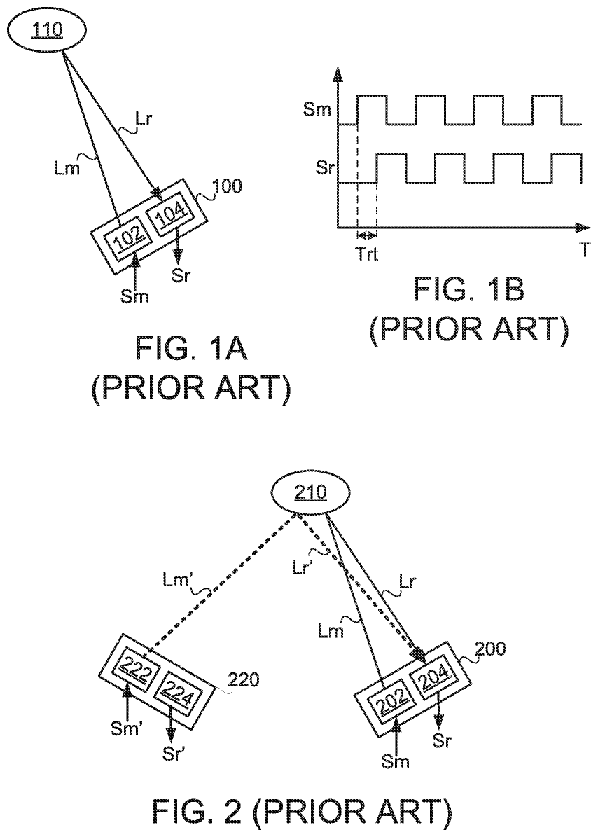

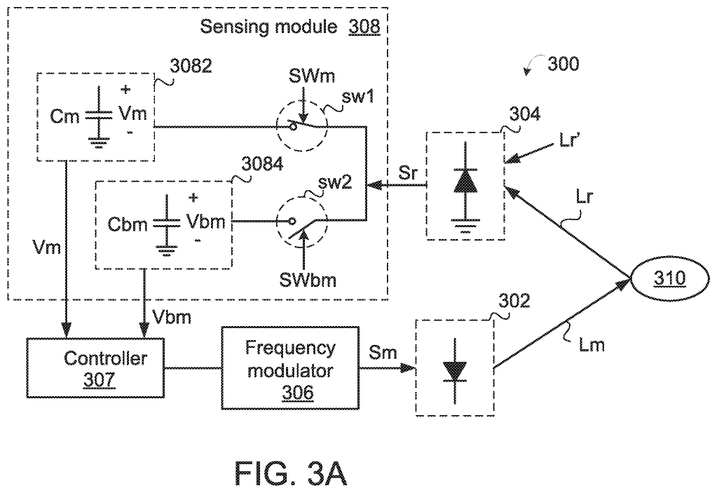

### DETAILED DESCRIPTION OF PREFERRED EMBODIMENTS

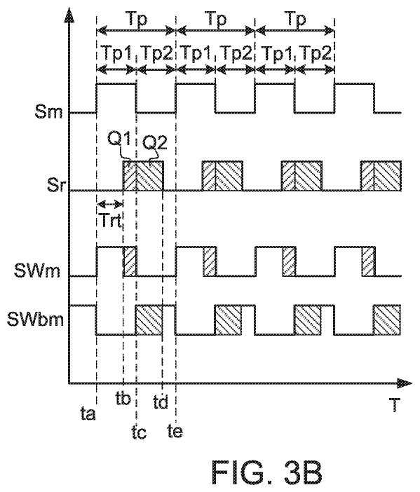

FIG. 3A is a schematic circuit block diagram illustrating the architecture of a TOF sensing system according to an embodiment of the present invention. As shown in FIG. 3A, the TOF sensing system 300 comprises a modulated light source 302, a frequency modulator 306, a photo detector 304, a sensing module 308 and a controller 307. The frequency modulator 306 provides a modulation signal Sm to the modulated light source 302. According to the modulation signal Sm, the modulated light source 302 emits a modulated light Lm. When the modulated light Lm is projected on an object 310, a reflected light Lr is generated and projected to the photo detector 304.

The sensing module 308 is connected with the photo detector 304. In an embodiment, the sensing module 308 comprises a first sensing circuit 3082 and a second sensing circuit 3084. The first sensing circuit 3082 is connected with the photo detector 304 through a first switch sw1. The second sensing circuit 3084 is connected with the photo detector 304 through a second switch sw2. The first sensing circuit 3082 comprises a first sensing element Cm. The second sensing circuit 3084 comprises a second sensing element Cbm. For example, the first sensing element Cm and the second sensing element Cbm are capacitors. The first switch sw1 is controlled by a switch signal SWm. The second switch sw2 is controlled by an inverted switch signal SWbm.

FIG. 3B is a schematic timing waveform diagram illustrating associated signal processed by the TOF sensing system as shown in FIG. 3A. As mentioned above, the modulated light source 302 emits the modulated light Lm according to the modulation signal Sm. Moreover, the modulation frequency and the phase of the modulation signal Sm are identical to those of the switch signal SWm. The inverted switch signal SWbm and the switch signal SWm are complementary to each other. As known, the modulation frequency is a reciprocal of the period. Consequently, if the modulation frequency is identical, the modulation signal Sm, the switch signal SWm and the inverted switch signal SWbm have the same period Tp.

In a first time segment Tp1 of the period Tp, the switch signal SWm is in the high level state and the inverted switch signal SWbm is in the low level state. In a second time segment Tp2 of the period Tp, the switch signal SWm is in the low level state and the inverted switch signal SWbm is in the high level state.

Please refer to FIG. 3A again. When the reflected light Lr is received by the photo detector 304, a reflection signal Sr is generated according to the reflected light Lr. For example, the reflection signal Sr is a sensing current.

When the switch signal SWm is in the high level state, the reflection signal Sr is transmitted to the sensing element Cm through the first switch sw1. Consequently, the quantity of charges stored in the sensing element Cm is subjected to a change. When the inverted switch signal SWbm is in the high level state, the reflection signal Sr is transmitted to the sensing element Cbm through the second switch sw2. Consequently, the quantity of charges stored in the sensing element Cbm is subjected to a change. For example, the charges in the sensing elements Cm and Cbm are gradually accumulated from the zero charge state, or the charges in the sensing elements Cm and Cbm are gradually released from the full charge state. In the following embodiment, it takes the charges in the sensing elements Cm and Cbm are gradually accumulated from the zero charge state as an example.

Please refer to FIG. 3B again. In the time interval between the time point ta and the time point tb, the switch signal SWm is in the high level state. Consequently, the reflection signal Sr is transmitted to the sensing element Cm through the first switch sw1. However, since the reflected light Lr is not detected by the photo detector 304 in the time interval between the time point ta and the time point tb, the reflection signal Sr from the photo detector 304 is in the low level state. Under this circumstance, no charges are transmitted to the sensing element Cm.

In the time interval between the time point tb and the time point tc, the switch signal SWm is in the high level state. Consequently, the reflection signal Sr is transmitted to the sensing element Cm through the first switch sw1. Since the reflected light Lr is detected by the photo detector 304 in the time interval between the time point tb and the time point tc, the charges of the reflection signal Sr (with the quantity Q1) are transmitted through the first switch sw1 and stored in the sensing element Cm.

In the time interval between the time point tc and the time point td, the inverted switch signal SWbm is in the high level state. Consequently, the reflection signal Sr is transmitted to the sensing element Cbm through the second switch sw2. Since the reflected light Lr is detected by the photo detector 304 in the time interval between the time point tc and the time point td, the charges of the reflection signal Sr (with the quantity Q2) are transmitted through the second switch sw2 and stored in the sensing element Cbm.

In the time interval between the time point td and the time point te, the inverted switch signal SWbm is in the high level state. Consequently, the reflection signal Sr is transmitted to the sensing element Cbm through the second switch sw2. However, since the reflected light Lr is not detected by the photo detector 304 in the time interval between the time point td and the time point te, the reflection signal Sr from the photo detector 304 is in the low level state. Under this circumstance, no charges are transmitted to the sensing element Cbm.

In other words, the reflection signal Sr is transmitted to the sensing element Cm and the charges Q1 are stored in the sensing element Cm during the first time segment Tp1 of the period Tp. Moreover, the reflection signal Sr is transmitted to the sensing element Cbm and the charges Q2 are stored in the sensing element Cbm during the second time segment Tp2 of the period Tp.

After the time point te, the above procedures are repeatedly done. In each cycle Tp, the charges Q1 are accumulated in the sensing element Cm, and the charges Q2 are accumulated in the sensing element Cbm. Consequently, the total charges Qm in the sensing element Cm and the total charges Qbm in the sensing element Cbm are increased continuously. The detailed principles will not be redundantly described herein.

After a predetermined time duration, the controller 307 acquires a sensing voltage Vm from the sensing element Cm and a sensing voltage Vbm from the sensing element Cbm. For example, the predetermined time duration is the time duration of one exposure that contains plural periods Tp. After the predetermined time duration, the controller 307 can acquire the sensing voltages Vm and Vbm corresponding to the charges in the sensing elements Cm and Cbm. Then, the charges in the sensing elements Cm and Cbm are discharged and the sensing procedure in the next predetermined time duration is performed.

In case that the charges in the sensing elements Cm and Cbm are gradually released from the full charge state, the controller 307 can acquire the sensing voltages Vm and Vbm corresponding to the charges in the sensing elements Cm and Cbm after the predetermined time duration. Then, the sensing elements Cm and Cbm are charged, and the sensing procedure in the next predetermined time duration is performed.

In an embodiment, the sensing elements Cm and Cbm are capacitors. Consequently, the sensing voltage Vm of the sensing element Cm is in direct proportion to the total charges Qm in the sensing element Cm, and the sensing voltage Vbm of the sensing element Cbm is in direct proportion to the total charges Qbm in the sensing element Cbm. According to the sensing voltage Vm of the sensing element Cm and the sensing voltage Vbm of the sensing element Cbm, the total charges Qm in the sensing element Cm and the total charges Qbm in the sensing element Cbm are calculated.

According to a ratio of Qm to Qbm (i.e., Qm/Qbm), a phase delay p value Trt is calculated. Please refer to FIG. 3B. In case that the ratio of Q1 to Q2 (i.e., Q1/Q2) is smaller, the phase delay value Trt is larger. Whereas, in case that the ratio of Q1 to Q2 (i.e., Q1/Q2) is larger, the phase delay value Trt is smaller.

In the above embodiment, the phase delay value Trt is calculated according to Qm/Qbm. It is noted that numerous modifications and alterations may be made while retaining the teachings of the invention. For example, in another embodiment, the phase delay value Trt is calculated according to the ratio of the sensing voltage Vm to the sensing voltage Vbm.

In practice, the reflected light Lr and another reflected light Lr′ are received by the photo detector 304 simultaneously. If the modulation frequency of the reflected light Lr and the modulation frequency of the reflected light Lr′ are different, the reflected light Lr′ is considered as the ambient light by the photo detector 304. Since the generation of the reflection signal Sr is not influenced by the reflected light Lr′, the phase delay value Trt calculated by the TOF sensing system 300 is accurate.

Whereas, if the modulation frequency of the reflected light Lr and the modulation frequency of the reflected light Lr′ are identical, the total charges Qm in the sensing element Cm and the total charges Qbm in the sensing element Cbm are influenced obviously. Consequently, the phase delay value Trt calculated by the TOF sensing system 300 is erroneous.

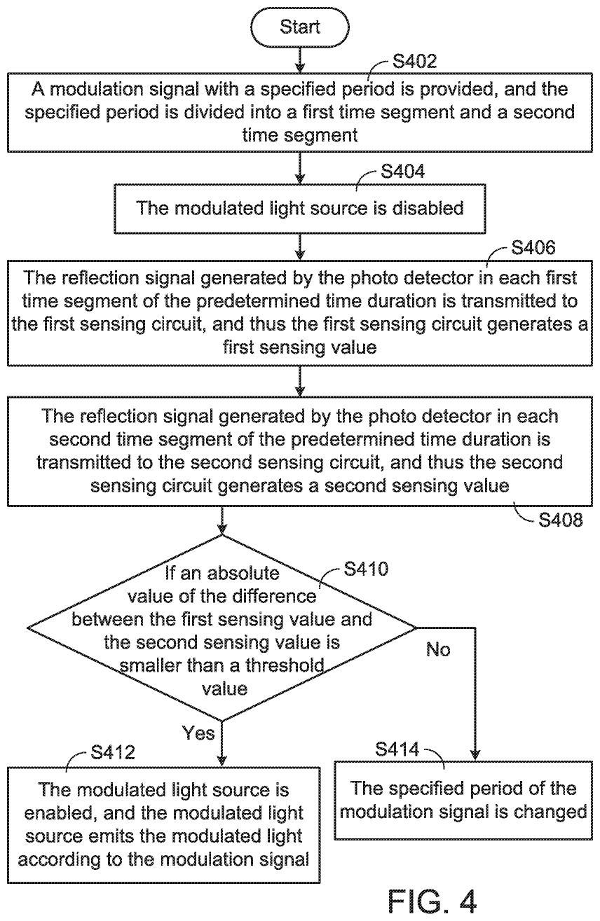

FIG. 4 is a flowchart illustrating a control method for a TOF sensing system according to a first embodiment of the present invention. The control method can avoid the interference between the TOF sensing system and the nearby TOF sensing system in the same scene.

Firstly, a modulation signal with a specified period is provided, and the specified period is divided into a first time segment and a second time segment (Step S402). Please also refer to FIG. 3B. In each specified period Tp of the modulation signal Sm, the former segment is the first time segment Tp1, and the latter segment is the second time segment Tp2.

Then, the modulated light source of the TOF sensing system is disabled (Step S404). Consequently, the modulated light source does not emit the modulated light. In this embodiment, the photo detector of the TOF sensing system detects the reflected light in the environment and generates the reflection signal when the modulated light is not emitted by the modulated light source. Moreover, according to the reflection signal, the TOF sensing system judges whether any other TOF sensing system emits the modulated light with the same modulation frequency. For example, the reflection signal is a sensing current.

Moreover, a predetermined time duration contains plural periods Tp. For example, the predetermined time duration is the time duration of one exposure. In other words, the predetermined time duration contains plural first time segments and plural second time segments. After the step S404, a step S406 and a step S408 are performed. In the step S406, the reflection signal generated by the photo detector in each first time segment of the predetermined time duration is transmitted to the first sensing circuit, so that the first sensing circuit generates a first sensing value. In the step S408, the reflection signal generated by the photo detector in each second time segment of the predetermined time duration is transmitted to the second sensing circuit, so that the second sensing circuit generates a second sensing value. The sensing value is a sensing voltage or a charge quantity corresponding to the sensing voltage.

Then, a step S410 is performed to judge whether an absolute value of the difference between the first sensing value and the second sensing value is smaller than a threshold value. If the judging condition of the step S410 is satisfied, the controller confirms that the TOF sensing system is not interfered by the nearby TOF sensing system. Then, the modulated light source is enabled, and the modulated light source emits the modulated light according to the modulation signal (Step S412). That is, the TOF sensing system enters the normal detecting state.

Whereas, if the judging condition of the step S410 is not satisfied, the controller confirms that the TOF sensing system is interfered by the nearby TOF sensing system. Then, the specified period of the modulation signal is changed (Step 414).

In case that the modulation frequency of the reflected light from any other TOF sensing system is not identical to the reflected light of the TOF sensing system, the absolute value of the difference between the first sensing value and the second sensing value is very small (e.g., nearly zero). If the absolute value of the difference between two sensing values (e.g., Vm and Vbm) is smaller than the threshold value, the TOF sensing system confirms that no other modulated light in the scene has the same modulation frequency as the modulated light of the TOF sensing system. Meanwhile, the modulated light source of the TOF sensing system is enabled, and the modulated light source emits the modulated light according to the modulation signal. Moreover, the photo detector detects the reflected light and generates a reflection signal is generated according to the reflected light. According to the modulation signal and the reflection signal, the TOF sensing system calculates a phase delay value Trt. That is, the TOF sensing system enters the normal detecting state.

In case that the modulation frequency of the reflected light from any other TOF sensing system is identical to the reflected light of the TOF sensing system, the absolute value of the difference between the first sensing value and the second sensing value is larger. If the absolute value of the difference between two sensing values (e.g., Vm and Vbm) is larger than the threshold value, the TOF sensing system confirms that another modulated light in the scene has the same modulation frequency as the modulated light of the TOF sensing system. Under this circumstance, the TOF sensing system has to change the modulation frequency of the modulation signal. That is, the controller 307 controls the frequency modulator 306 to change the specified period of the modulation signal. If the specified period of the modulation signal is not changed, the phase delay value Trt calculated by the TOF sensing system is erroneous.

After the modulation frequency of the modulation signal is changed, the modulation signal has another period. Then, the flowchart of FIG. 4 is repeatedly done to judge whether the modulation frequency of the reflected light from any other TOF sensing system is identical to the reflected light of the TOF sensing system. Until the controller confirms that the TOF sensing system is not interfered, the modulated light source is enabled, and the modulated light source emits the modulated light according to the modulation signal (Step S412). That is, the TOF sensing system enters the normal detecting state.

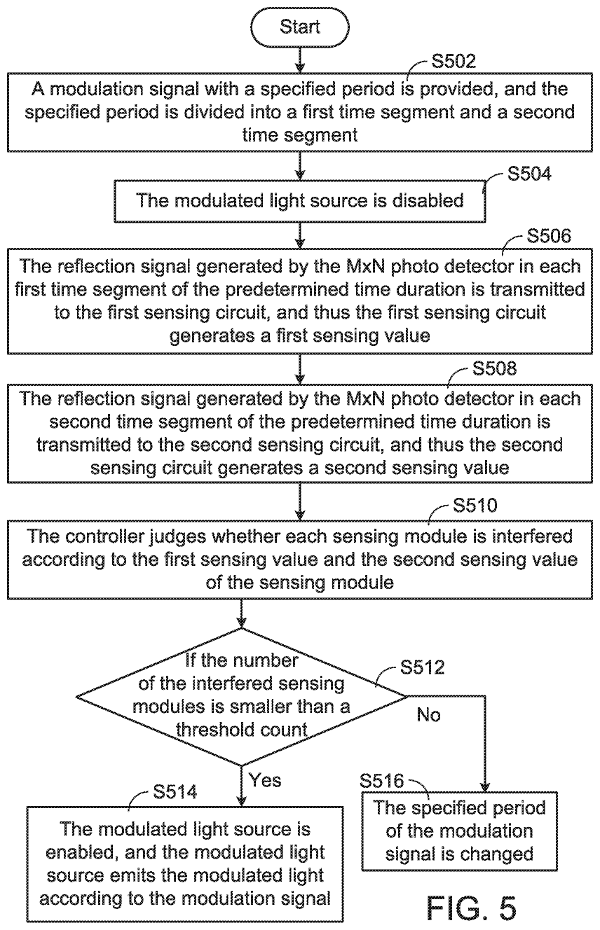

The control method of the first embodiment may be further modified. For example, the control method may be applied to a TOF sensing system with a photo detecting matrix. FIG. 5 is a flowchart illustrating a control method for a TOF sensing system according to a second embodiment of the present invention. The photo detecting matrix of the TOF sensing system comprises plural photo detectors, wherein are arranged in an M×N array. Each photo detector is electrically connected with one corresponding sensing module. Each sensing module comprises a first sensing circuit and a second sensing circuit. The connecting relationships and the operations of the photo detector and the corresponding sensing module are similar to those of FIGS. 3A and 3B, and are not redundantly described herein.

Firstly, a modulation signal with a specified period is provided, and the specified period is divided into a first time segment and a second time segment (Step S502).

Then, the modulated light source of the TOF sensing system is disabled (Step S504). Consequently, the modulated light source does not emit the modulated light. In this embodiment, the photo detectors of the TOF sensing system detect the reflected light in the environment and generate the reflection signal when the modulated light is not emitted by the modulated light source. Moreover, according to the reflection signal, the TOF sensing system judges whether any other TOF sensing system emits the modulated light with the same modulation frequency. For example, the reflection signal is a sensing current.

Moreover, a predetermined time duration contains plural periods Tp. For example, the predetermined time duration is the time duration of one exposure. In other words, the predetermined time duration contains plural first time segments and plural second time segments. After the step S504, a step S506 and a step S508 are performed. In the step S506, the reflection signal generated by the M×N photo detectors in each first time segment of the predetermined time duration is transmitted to the first sensing circuit, so that the first sensing circuit generates a first sensing value. In the step S508, the reflection signal generated by the M×N photo detector in each second time segment of the predetermined time duration is transmitted to the second sensing circuit, so that the second sensing circuit generates a second sensing value. The sensing value is a sensing voltage or a charge quantity corresponding to the sensing voltage.

Then, the controller judges whether each sensing module is interfered according to the first sensing value and the second sensing value of the sensing module (Step S510). In the step S510, the steps S410, S412 and S414 of the control method of the first embodiment may be used to judge whether each sensing module is interfered. If the absolute value of the difference between two sensing values (e.g., Vm and Vbm) is smaller than the threshold value, the controller confirms that the sensing module is not interfered. Whereas, if the absolute value of the difference between the two sensing values (e.g., Vm and Vbm) is larger than the threshold value, the controller confirms that the sensing module is interfered. Then, the TOF sensing system calculates the number of the interfered sensing modules among the M×N sensing modules.

Then, a step S512 is performed to judge whether the number of the interfered sensing modules is smaller than a threshold count (Step S512). If the judging condition of the step S512 is satisfied, the modulated light source is enabled, and the modulated light source emits the modulated light according to the modulation signal (Step S514). Whereas, if the judging condition of the step S512 is not satisfied, the specified period of the modulation signal is changed (Step 516).

After the modulation frequency of the modulation signal is changed, the modulation signal has another period. Then, the flowchart of FIG. 5 is repeatedly done to judge whether the modulation frequency of the reflected light from any other TOF sensing system is identical to the reflected light of the TOF sensing system. Until the controller confirms that the number of the interfered sensing modules is smaller than a threshold count, the modulated light source is enabled, and the modulated light source emits the modulated light according to the modulation signal (Step S514). That is, the TOF sensing system enters the normal detecting state.

From the above descriptions, the present invention provides a control method for TOF sensing system. When the modulated light is not emitted by the modulated light source, the photo detector of the TOF sensing system detects the reflected light in the environment and generates the reflection signal. Moreover, according to the reflection signal, the TOF sensing system judges whether any other TOF sensing system emits the modulated light with the same modulation frequency. If any other TOF sensing system emits the modulated light with the same modulation frequency, the modulation frequency of the reflected light is changed properly.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control method for a time-of-flight sensing system, the time-of-flight sensing system comprising a modulated light source, a photo detector, a first sensing circuit and a second sensing circuit, the control method comprising steps of:
providing a modulation signal with a specified period, wherein the specified period is divided into a first time segment and a second time segment;
disabling the modulated light source, wherein a reflection signal generated by the photo detector in each first time segment is transmitted to the first sensing circuit, and the reflection signal generated by the photo detector in each second time segment is transmitted to the second sensing circuit, so that the first sensing circuit generates a first sensing value and the second sensing circuit generates a second sensing value;
judging whether the time-of-flight sensing system is interfered according to the first sensing value and the second sensing value;
if the time-of-flight sensing system is not interfered, enabling the modulated light source, and the modulated light source emits a modulated light according to the modulation signal; and
if the time-of-flight sensing system is interfered, changing the specified period of the modulation signal.

2. The control method as claimed in claim 1, wherein if an absolute value of a difference between the first sensing value and the second sensing value is smaller than a threshold value, the time-of-flight sensing system is not interfered, wherein if the absolute value of the difference between the first sensing value and the second sensing value is larger than the threshold value, the time-of-flight sensing system is interfered.

3. The control method as claimed in claim 1, wherein the first sensing value is a first sensing voltage, and the second sensing value is a second sensing voltage.

4. The control method as claimed in claim 1, wherein the first sensing value is a first charge quantity, and the second sensing value is a second charge quantity.

5. The control method as claimed in claim 1, wherein the photo detector receives a reflected light and generates the reflection signal according to the reflected light, wherein the reflection signal is transmitted to the first sensing circuit and the second sensing circuit alternately.

6. A control method for a time-of-flight sensing system, the time-of-flight sensing system comprising a modulated light source, a photo detecting matrix and plural sensing modules, the photo detecting matrix comprising plural photo detectors, the plural photo detectors being connected with the corresponding sensing modules, the control method comprising steps of:
providing a modulation signal with a specified period, wherein the specified period is divided into a first time segment and a second time segment;
disabling the modulated light source, wherein a reflection signal generated by each photo detector in each first time segment is transmitted to a first sensing circuit of the corresponding sensing module and the reflection signal generated by each photo detectors in each second time segment is transmitted to a second sensing circuit of the corresponding sensing module, so that the first sensing circuit generates a first sensing value and the second sensing circuit generates a second sensing value;
judging whether each sensing module is interfered according to the first sensing value and the second sensing value;
judging whether a number of the interfered sensing modules is smaller than a threshold count;
if the number of the interfered sensing modules is smaller than the threshold count, enabling the modulated light source, and the modulated light source emits a modulated light according to the modulation signal; and
if the number of the interfered sensing modules is larger than the threshold count, changing the specified period of the modulation signal.

7. The control method as claimed in claim 6, wherein if an absolute value of a difference between the first sensing value and the second sensing value of each sensing module is smaller than a threshold value, the sensing module is not interfered, wherein if the absolute value of the difference between the first sensing value and the second sensing value of each sensing module is larger than the threshold value, the sensing module is interfered.

8. The control method as claimed in claim 6, wherein the first sensing value is a first sensing voltage, and the second sensing value is a second sensing voltage.

9. The control method as claimed in claim 6, wherein the first sensing value is a first charge quantity, and the second sensing value is a second charge quantity.

10. The control method as claimed in claim 6, wherein each photo detector receives a reflected light and generates the reflection signal according to the reflected light, wherein the reflection signal is transmitted to the first sensing circuit and the second sensing circuit of the corresponding sensing module alternately.
